(19) United States
(12) Patent Application Publication
(10) Pub. No.: US 2010/0257018 A1
(43) Pub. Date: Oct. 7, 2010

(54) ENHANCED SEARCH MARKETING

(75) Inventor: Ambarish Nagarajan, Bangalore (IN)

Correspondence Address: Evergreen Valley Law Group, P.C. and Yahoo! Inc., 4 South Second Street, Suite 598, San Jose, CA, 95113, US

(73) Assignee: YAHOO! INC., Sunnyvale, CA (US)

(21) Appl. No.: 12/416,931

(22) Filed: Apr. 2, 2009

(51) Int. Cl. G06Q 10/00; G06Q 30/00

(52) U.S. Cl. 705/10; 705/26

(57) ABSTRACT

Enhanced search marketing. A method includes generating a link corresponding to a product of an advertiser and providing the link to a purchaser after purchase of the product of the advertiser. Further, the method includes adding information associated with the product to a list of online bookmarks in response to the purchaser clicking the link. Furthermore, the method includes receiving a search query corresponding to the product from a user, searching the list of online bookmarks and displaying the information associated with the product to the user.

### BACKGROUND

In the current scenario, online search engines implement sponsored search marketing. The sponsored search marketing is a form of online search marketing that seeks to promote websites and products associated with advertisers to potential purchasers by increasing visibility of the websites and the products associated with the advertisers in search engine result pages (SERPs). However, a purchaser of products may not feel confident about purchasing a product solely based on search results due to lack of feedback or recommendations attesting to the quality of the product. One resource for such knowledge can be an existing customer of the product who can provide feedback or recommendation regarding quality of the product. However, in the context of sponsored search marketing, search results by themselves may not provide a useful indication from existing customers on the quality of the product to purchasers. A potential purchaser may also consider an online purchase of a product through traditional bidding and shopping websites. However, traditional bidding and shopping websites may also lack value-added information from existing customers regarding the quality of the product showcased for bidding. Further, the potential purchaser may also consider an online purchase of a product through social shopping websites providing detailed review of each product. However, the detailed review of a product may not be accurate and worse still be subject to bias from service providers hosting the social shopping websites.

In light of foregoing discussion there is a need for a technique for enhanced search marketing.

### SUMMARY

Embodiments of the present disclosure described herein provide a method, system and article of manufacture for enhanced search marketing.

An example of an article of manufacture includes a machine-readable medium. The machine-readable medium carries instructions operable to cause a programmable processor to perform generating a link corresponding to a product of an advertiser. Further, the machine-readable medium carries instructions operable to cause the programmable processor to perform providing the link to a purchaser of a product of the advertiser after purchase of the product. Furthermore, the machine-readable medium carries instructions operable to cause the programmable processor to perform adding information associated with the product to a list of online bookmarks in response to the purchaser clicking the link. Moreover, the machine-readable medium carries instructions operable to cause the programmable processor to perform receiving a search query corresponding to the product from a user and searching the list of online bookmarks and displaying the information associated with the product to the user.

Another example of an article of manufacture includes a machine-readable medium. The machine-readable medium carries instructions operable to cause a programmable processor to perform generating a link corresponding to a product of an advertiser. Further, the machine-readable medium carries instructions operable to cause the programmable processor to perform receiving a search query corresponding to a product of the advertiser from a user, searching the list of online bookmarks and displaying a URL associated with the product to the user. Moreover, the method includes displaying a web page corresponding to the URL to the user in response to the user clicking the URL, providing the link to the user after purchase of the product, and updating information associated with the product in the list of online product bookmarks in response to user inputs.

An example of a computer implemented method includes generating a link corresponding to a product of an advertiser. Further, the computer implemented method includes providing the link to a purchaser of a product of the advertiser after purchase of the product. Furthermore, the computer implemented method includes adding information associated with the product to a list of online bookmarks in response to the purchaser clicking the link. The computer implemented method also includes, searching the list of online bookmarks and displaying the information associated with the product to the user.

An example of a system includes a purchaser electronic device for displaying a link associated with a product of an advertiser to a purchaser of a product of the advertiser. Further, the system includes a user electronic device for inputting a search query corresponding to the product. The system also includes a communication interface in electronic communication with the purchaser electronic device and the user electronic device. Furthermore, the system includes a memory for storing instructions. Moreover, the system includes a processor responsive to the instructions for adding information associated with the product to the list of online bookmarks in response to the purchaser clicking the link, and displaying the information associated with the product to a user as a search result. The system also includes one or more storage devices in electronic communication with the communication interface for storing a list of online bookmarks.

### BRIEF DESCRIPTION OF THE FIGURES

FIG. 1 is a block diagram of an environment, in accordance with which various embodiments can be implemented;

FIG. 2 is a block diagram of an electronic device, in accordance with one embodiment;

FIG. 3 is a flowchart illustrating a method for search marketing based on online bookmaking, in accordance with one embodiment;

FIG. 4 is a flowchart illustrating method steps performed by an advertiser, in accordance with one embodiment;

FIGS. 5A-5B illustrate exemplary incentive rules and exemplary link, in accordance with one embodiment;

FIG. 6 is a flowchart illustrating a method for adding information associated with a product, for example a laptop to a list of online bookmarks by a purchaser, in accordance with one embodiment; and

FIG. 7 is a flowchart illustrating a method of updating information associated with a product in a list of online bookmarks by a user, in accordance with one embodiment.

### DETAILED DESCRIPTION OF THE EMBODIMENTS

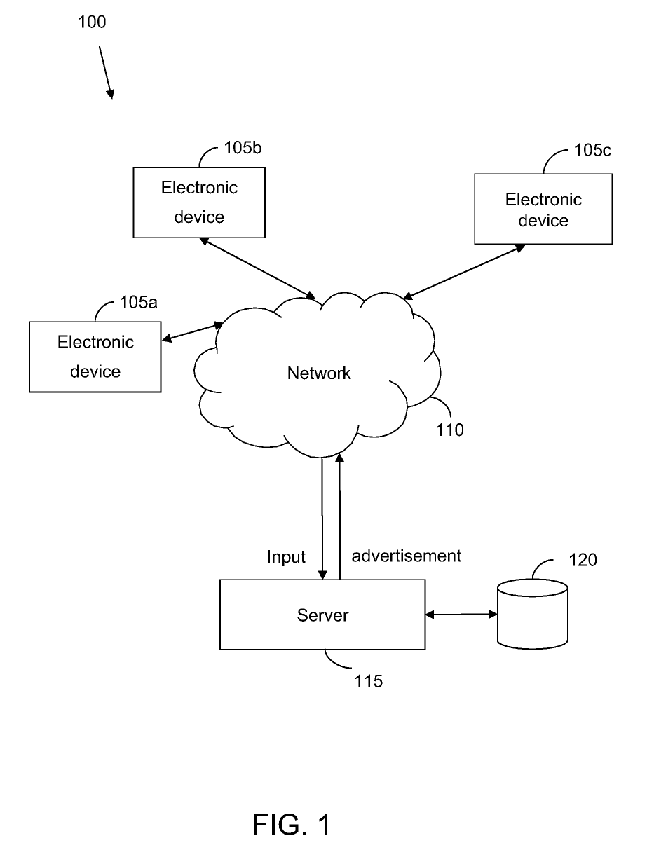

FIG. 1 is a block diagram of an environment 100, in accordance with which various embodiments can be implemented. The environment 100 includes one or more electronic devices, for example an electronic device 105a, an electronic device 105b, and electronic device 105c, connected to each other through a network 110. Examples of the electronic devices include, but are not limited to, computers, laptops, mobile devices, hand held devices, and personal digital assistants (PDAs). Examples of the network 110 include but are not limited to a Local Area Network (LAN), a Wireless Local Area Network (WLAN), a Wide Area Network (WAN), internet and a Small Area Network (SAN). The electronic devices are also connected to a server 115 through the network 110. The server 115 is connected to a storage device 120.

In some embodiments, the electronic device 105a can correspond to a purchaser electronic device of a purchaser, the electronic device 105b can correspond to a user electronic device of a user and the electronic device 105c can correspond to an advertiser electronic device of an advertiser.

The advertiser of a product can create an advertiser account with a service provider, for example, Yahoo!®, using the advertiser electronic device. In one embodiment, the account details can be stored in the storage device 120 and can be accessed by the server 115. The account details can include advertiser information, advertisements, banners, advertising strategy and allocation of funds for display of the advertisements and the banners.

At the time of creating an account or anytime thereafter, the advertiser can register for various services, including a search marketing service based on online book marking, provided by the service provider through the advertiser electronic device. The online bookmarking facilitates users to store, organize, share, search, and manage bookmarks online. A user can bookmark a web page and the web page once bookmarked gets added to a list of online bookmarks and can be searched and accessed by any user. A link is generated by the server 115 for the product of the advertiser in response to the advertiser registering for the enhanced search marketing service based on online book marking. The link can be referred to as the link associated with the product of the advertiser.

A potential purchaser of a product searches for the product using a search engine such as Yahoo!® Search and various advertisements related to the product are displayed. The potential purchaser can then visit a web page corresponding to an advertisement and purchase the product of the advertiser. After completion of the purchase, the link associated with the product of the advertiser is displayed to a purchaser on the purchaser electronic device. The purchaser can be defined as a person purchasing the product. The purchaser can then choose, for example by clicking on the link, to add information associated with the product to a list of online bookmarks. The information includes a uniform resource locator (URL). The information can additionally include a review, a rating, a tag and a note. The list of online bookmarks is stored in the storage device 120 and can be accessed through the network 110. The list of online bookmarks is updated with the information associated with the product.

In some embodiments, the link can be sent to the purchaser any time after the purchase through email or any other mode of communication. The purchaser can then provide the information.

In one embodiment, the list of online bookmarks is searchable and accessible to users through an online book marked product search website. A user of the user electronic device accesses the website and inputs a search query corresponding to the product. A user can be defined as a person visiting the online book marked product search website. The search query for the product of the interest is communicated to the server 115 through the network 110 by the user electronic device. The server 115 searches the list of online bookmarks and displays the information associated with the product as a search result.

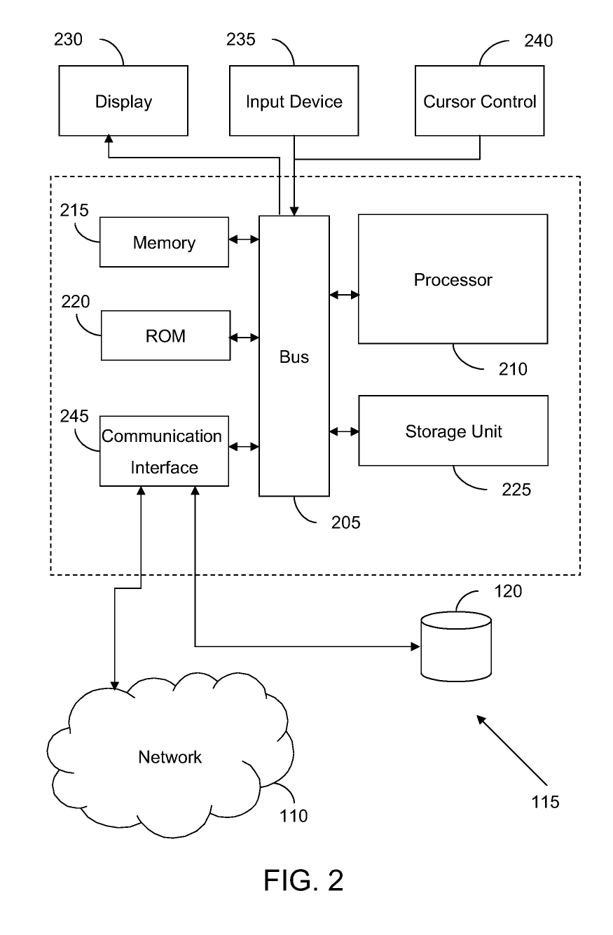

The server 115 includes a plurality of elements for enabling search marketing through online bookmarking. The server 115 including the elements is explained in detail in FIG. 2.

FIG. 2 is a block diagram of a server 115, in accordance with one embodiment. The server 115 includes a bus 205 for communicating information, and a processor 210 coupled with the bus 205 for processing information. The server 115 also includes a memory 215, for example a random access memory (RAM) coupled to the bus 205 for storing instructions to be executed by the processor 210. The memory 215 can be used for storing temporary information required by the processor 210. The server 115 further includes a read only memory (ROM) 220 coupled to bus 205 for storing static information and instructions for the processor 210. A server storage unit 225, for example a magnetic disk, hard disk or optical disk, can be provided and coupled to bus 205 for storing information and instructions.

The server 115 can be coupled via the bus 205 to a display 230, for example a cathode ray tube (CRT) or liquid crystal display (LCD), for displaying information. An input device 235, including various keys, is coupled to the bus 205 for communicating information and command selections to the processor 210. In some embodiments, cursor control 240, for example a mouse, a trackball, a joystick, or cursor direction keys for command selections to the processor 210 and for controlling cursor movement on the display 230 can also be present.

In one embodiment, the steps of the present disclosure are performed by the server 115 in response to the processor 210 executing instructions included in the memory 215. The instructions can be read into the memory 215 from a machine-readable medium, for example the server storage unit 225. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The server storage unit 225 can be a non-volatile media. The memory 215 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 210.

The server 115 also includes a communication interface 245 coupled to the bus 205 for enabling data communication. Examples of the communication interface 245 include, but are not limited to, an integrated services digital network (ISDN) card, a modem, a local area network (LAN) card, an infrared port, a Bluetooth port, a zigbee port, and a wireless port.

In some embodiments, the processor 210 generates the link corresponding to the product of the advertiser. The advertiser can provide the link generated to the purchaser of the product of the advertiser. Further, the processor 210 adds the information associated with the product to the list of online bookmarks in response to the purchaser clicking the link. The processor 210 receives a search query corresponding to the product from the user. The processor 210 searches the list of online bookmarks based on the search query. In addition, the processor 210 displays the information associated with the product to the user as the search result.

In some embodiments, the processor 210 can include one or more processing units for performing one or more functions of the processor 210. The processing units are hardware circuitry performing specified functions.

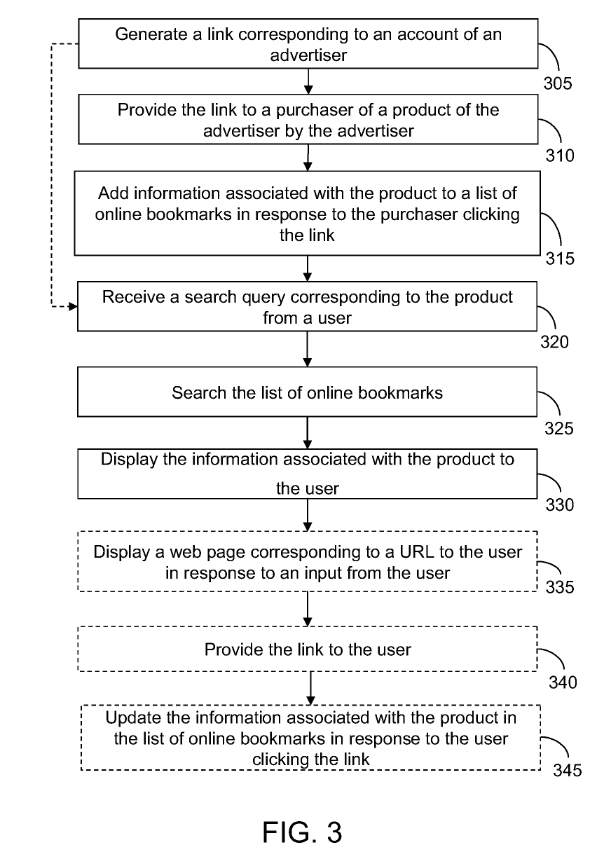

FIG. 3 is a flowchart illustrating a computer implemented method for search marketing based on online bookmarking, in accordance with one embodiment.

An advertiser of a product can create an advertiser account with a service provider, for example, Yahoo!®. The advertiser configures the account by registering for an enhanced search marketing service based on online book marking. The advertiser can also allocate and manage costs associated with the enhanced search marketing service.

At step 305, a link corresponding to the product of the advertiser is generated. The link is generated in response to the advertiser registering for the enhanced search marketing service.

In some embodiments, one or more links can be generated corresponding to one or more products of the advertiser. For example, if the advertiser requires the enhanced search marketing service based on the online bookmarking to be implemented for two products, product A and product B, then two links corresponding to the product A and the product B can be generated.

At step 310, the link is provided to a purchaser of the product of the advertiser. A potential purchaser of a product searches for the product using various search engines, for example Yahoo! Search engine, and various advertisements related to the product are displayed. The purchaser can then visit a web page corresponding to an advertisement and purchase the product of the advertiser. After completion of the purchase the link associated with the product of the advertiser is displayed to the purchaser. The purchase can be detected by an advertiser server.

In some embodiments, display of the link can be customized. For example, a purchaser incentive banner can be displayed with a message “GET CASH BACK UPTO 20% BY CLICKING HERE”.

The advertiser may choose to provide the link at various stages involved in purchasing of the product or at any instant of time after the purchase.

The link can be provided electronically in various ways to the purchaser, for example through electronic mail and short service message.

At step 315, information associated with the product is added to a list of online bookmarks in response to an input from the purchaser. The input can include the purchaser clicking the link. The information associated with the product includes a URL. The URL can correspond to advertiser's home page, the product web page and such similar web pages. The information can optionally include at least one of a review, a rating, a title, a tag, and a note. The list of online bookmarks is updated with the information of the product and stored.

Each online bookmark corresponds to the information associated with a respective product.

In some embodiments, steps 310 and 315 can be bypassed. The advertiser can provide URLs of various products web page initially while registering for the enhanced search marketing service and such URLs can be added as online bookmarks to the list of online bookmarks in the online book marked product search website with count as zero.

At step 320, a search query corresponding to the product is received from a user. The search query can include a key word or a key phrase associated with the product. The list of the online bookmarks can be searchable and made available to users through an online book marked product search website. The user accesses the website and inputs a search query corresponding to the product.

At step 325, the list of online bookmarks is searched based on the search query. The search query is mapped with the information associated with the product in the list of online bookmarks. For example, the keywords or the key phrases in the search query are mapped with similar keywords or key phrases in the information associated with the product in the list of online bookmarks.

At step 330, the information associated with the product is displayed to the user as a search result.

In some embodiments, the display of the information can be customized. For example, product name hyperlinked to the URL can be displayed or the URL can be displayed. The review, the rating, the tag, the title, and the note associated with the product can also be provided in form of clickable links.

The display of the information of the product also includes displaying the count of number of times the link corresponding to the product has been clicked. The information associated with the product can be prioritized based on the number of clicks and displayed to the user.

At step 335, a web page corresponding to the URL is displayed in response to an input from the user. The input can include the user clicking the display of the information associated with the product.

In some embodiments, the user may be prompted to provide login details in response to the input from the user. The user can then be authenticated based on the login details and directed to the web page corresponding to the URL.

At step 340, the link is provided to the user. After completion of the purchase the link associated with the product of the advertiser is displayed to the user. The purchase can be detected by an advertiser server. Alternatively, the advertiser can choose to display the link during any other stage of the purchase.

The display of the link can be customized. The link can be provided electronically in various ways to the user, for example electronic mail and short service message.

In some embodiments, the user may also be prompted to provide information regarding user experience for online book marked product search website.

At step 345, the information associated with the product in the list of online bookmarks is then updated in response to the user clicking the link. The count of the number of clicks of the link is incremented by one in the list of online bookmarks.

In some embodiments, monetary benefits based on pre-defined incentive rules associated with the link can be provided to the purchaser or the user after the purchase of the product. The monetary benefits can be provided to the purchaser or the user purchasing the product and clicking the link. The pre-defined incentive rules for the purchaser or the user can include a fixed amount or a percentage discount on the amount of the product purchased. The monetary benefits can be credited to an account of the purchaser or the user clicking the link utilizing the purchase details of the user or the purchaser.

In some embodiments, the monetary benefits can also be provided to the online book marked product search service provider. For example, a fixed amount can be provided to the service provider for every purchase initiated from clicking of the information displayed as the search result. A track can be maintained by the service provider by prompting the user to provide the login details in response to the user clicking the information display. The time of providing login details for viewing the webpage and the time when the user completes the purchase and clicks on the link can be noted and the difference between the two can be checked against a pre-defined threshold. If the time difference is less than the threshold then the transaction can be considered to be initiated from clicking of the information displayed as the search result.

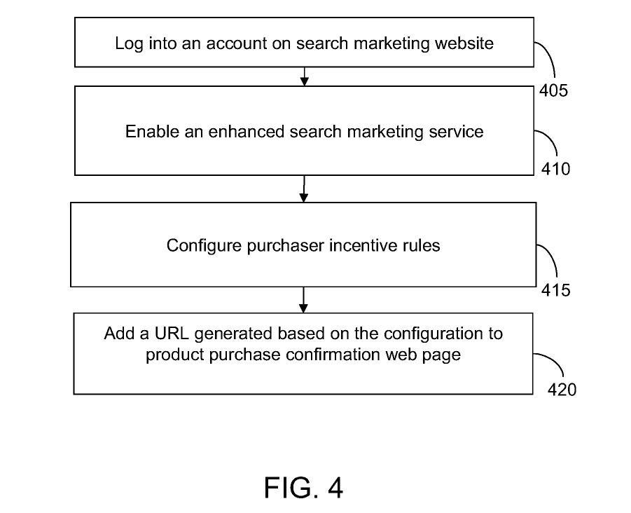

FIG. 4 is a flowchart illustrating method steps performed by an advertiser, in accordance with one embodiment.

At step 405, an advertiser logs into an advertiser account on search marketing website, such as Yahoo!® search marketing website. If the advertiser is not registered, the advertiser can create the advertiser account.

At step 410, the advertiser subscribes for the enhanced search marketing service. The enhanced search marketing service is offered to the advertiser in addition to sponsored search marketing. The enhanced search marketing service can be defined as including an online bookmark corresponding to a product of an advertiser in a list of online product bookmarks and hosting the list on online book marked product search website.

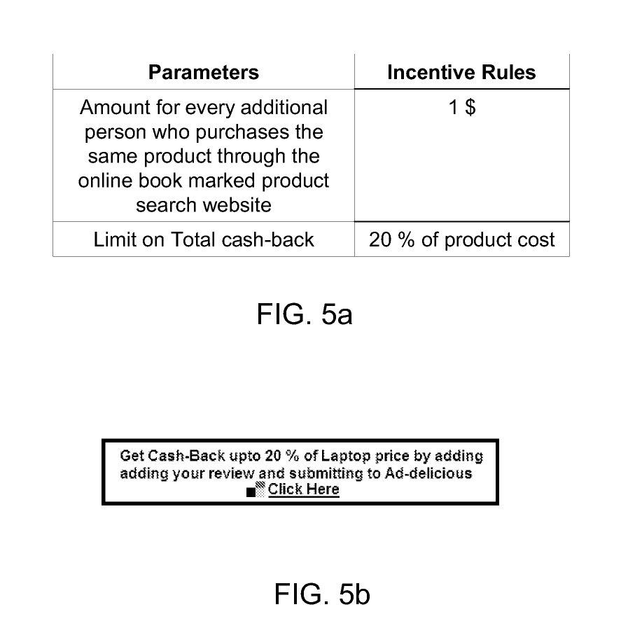

At step 415, purchaser incentive rules are configured by the advertiser. The purchaser incentive rules configured by the advertiser are exemplarily illustrated in FIG. 5A. For example, the advertiser can determine an amount to be given as discount or cash back for every additional user who purchases the product through the online book marked product search website. The advertiser can also set an upper limit on the cash back.

At step 420, the advertiser adds a link or a uniform resource locator (URL) generated based on the configuration of the purchaser incentive rules to a product purchase confirmation web page on the advertiser's website. The link generated can be customized to include different captions. The link added to the product purchase confirmation web page is exemplarily illustrated in FIG. 5B.

FIG. 5A illustrates exemplary incentive rules, in accordance with one embodiment. The advertiser determines $1 to be given as discount or cash back for every additional user who purchases the product through the online book marked product search website. The advertiser also sets an upper limit on the cash back as 20% of the product cost.

FIG. 5B illustrates an exemplary link, in accordance with one embodiment.

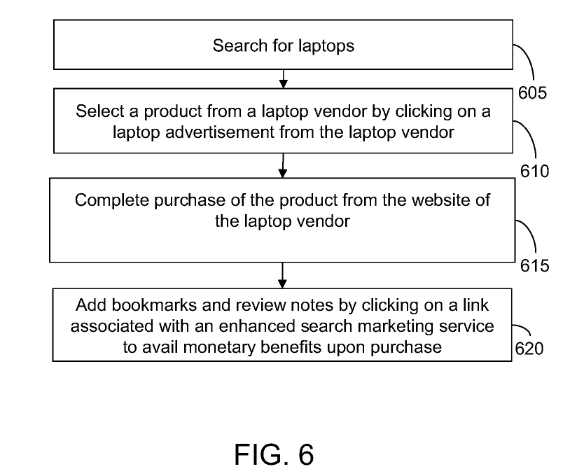

FIG. 6 is a flowchart illustrating a method for adding information associated with a product, for example a laptop to a list of online bookmarks by a purchaser, in accordance with one embodiment.

At step 605, the purchaser interested in purchasing a laptop searches for laptops using an online search engine, for example, Yahoo!® Search. Search results and sponsored advertisements associated with the laptops are displayed to the purchaser. The search results and the sponsored advertisements can correspond to links associated with laptop vendors.

At step 610, the purchaser selects product from a laptop vendor based on the purchaser's preferences by clicking on a laptop advertisement in the search results or the sponsored advertisements associated with the laptop vendor. The purchaser is then directed to a website of the laptop vendor on clicking the laptop advertisement.

In some embodiments, the purchaser can also be directed directly to a product purchase web page on the laptop vendor's website.

At step 615, the purchaser completes purchase of the product from the laptop vendor's website. The product purchased corresponds to a laptop purchased by the purchaser. The purchaser can be provided a link associated with an enhanced search marketing service after purchase of the product. Monetary benefits can be offered to the purchaser if the purchaser bookmarks the web page associated with the product purchased and provides reviews or ratings on the product purchased by clicking the link.

Information associated with the purchaser can be stored by the laptop vendor.

In some embodiments, the link can be provided at any instant of time after the purchase through various ways, for example, electronic mail and short service message.

At step 620, the purchaser adds online bookmarks and review notes corresponding to the product purchased or the laptop vendor by clicking on a link associated with the enhanced search marketing service in order to avail monetary benefits after purchase of the product. The review notes from the purchaser can include, but not limited to, purchaser satisfaction regarding aspects of utility and quality of the product purchased, shopping experience, quality of customer service provided the laptop vendor for the product purchased, and endorsements for the laptop vendor to other potential customers of the laptop vendor.

In some embodiments, information on count of the online bookmarks and the review notes received from the purchaser corresponding to the product purchased or the laptop vendor can be displayed to multiple purchasers searching for the product through at least one of sponsored search marketing and the enhanced search marketing. The information associated with the product can be displayed along with sponsored advertisements of the laptop vendor on a search engine, for example, Yahoo!® Search when a user searches for the product using the search engine. The information associated with the product can also be provided to a user using the enhanced search marketing service through a list of online bookmarks presented to the user in response to a search query associated with the product from the user.

Predefined incentive rules and budget are set by the laptop provider using the enhanced search marketing service to provide monetary benefits to the purchasers clicking the link. Monetary benefits can then be provided by to the purchaser based on the predefined incentive rules and budget set by the laptop provider. The monetary benefits can include, but not limited to, cash-back or discounts on the product purchased, gift coupons, and discount coupons.

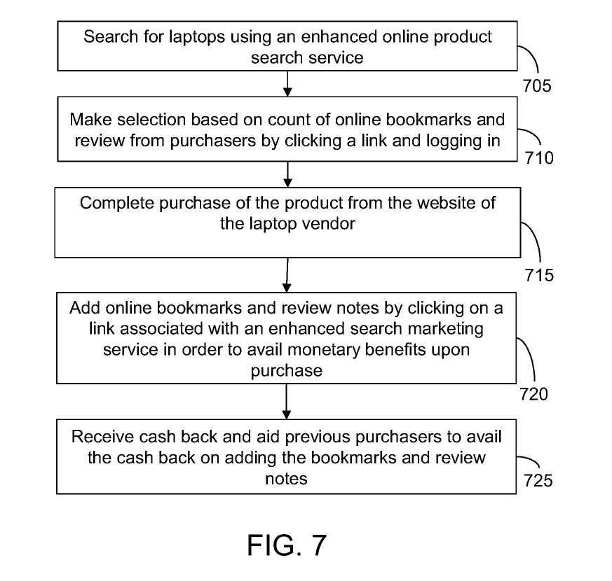

FIG. 7 is a flowchart illustrating a method of updating information associated with a product, for example a laptop, in a list of online bookmarks by a user, in accordance with one embodiment.

An enhanced online product search service is provided to a user in form of an on online book marked product search website. The user can register to the enhanced online product search service. The user can use the enhanced online product search service by logging in using a username and a password. The enhanced online product search service displays information associated with the product to the user in response to a search query entered by the user. The information associated with the product is obtained from purchasers of the product after successful purchase of the product and a list of online bookmarks is created. In another aspect, the advertiser can provide the URLs of the webpage of the product.

In some embodiments, the users can be assured of the authenticity of the information associated with the product since only actual purchasers of the product can provide the information to the enhanced online product search service. In another embodiment, the information can be provided by a potential purchaser also. Such cases may occur when the advertiser provides the link to the potential purchaser before completion of the purchase.

At step 705, the user searches for laptops using an enhanced online product search service. Information associated with the laptops is provided to the user. The information can include, but not limited to, count of online bookmarks associated with the laptops and reviews or ratings for the laptops obtained from the actual purchasers of the laptops.

At step 710, the user makes a selection based on count of online bookmarks and review from purchasers corresponding to a laptop of interest by clicking a link associated with the laptop in the information displayed and logging in. The user is prompted to log in upon clicking the link to verify authenticity of the user and ensure initiation of purchase of the laptop through the enhanced online product search service. The user can be directed to a website of the laptop vendor for the laptop on clicking the link.

In some embodiments, the user can also be directed directly to a product purchase web page on the laptop vendor's website.

At step 715, the user completes purchase of the product from the laptop vendor's website. The product purchased corresponds to a laptop purchased by the user from the laptop vendor relying on reviews and count of online bookmarks in the information associated with the laptop displayed by the enhanced online product search service. The user can be provided a link associated with an enhanced online product search service after purchase of the product. Monetary benefits can be assured to the user if the user bookmarks the web page associated with the product purchased and provides reviews or ratings on the product purchased by clicking the link.

Information associated with the user can be stored by the laptop vendor. The laptop vendor can also intimate the user regarding monetary benefits on clicking the link at any instant of time after the purchase through various ways, for example, electronic mail and short service message.

At step 720, the user adds online bookmarks and review notes corresponding to the product purchased or the laptop vendor by clicking on the link associated with the enhanced online product search engine in order to avail the monetary benefits after purchase of the product. The review notes from the user can include, but not limited to, authenticity of information received from the purchasers aiding the purchase by the user, review or ratings on the purchasers aiding the purchase, user satisfaction regarding aspects of utility and quality of the product purchased, shopping experience, quality of customer service provided the laptop vendor for the product purchased, and endorsements for the laptop vendor to other potential customers of the laptop vendor.

The count of online bookmarks associated with product or laptop is incremented by one when the user clicks the link associated with the enhanced online product search service provided by the laptop vendor and the count of online bookmarks is updated. The updated count of bookmarks is reflected in the information displayed to all users when a new search associated with the product is performed using the enhanced online product search service after the user clicking the link.

At step 725, the user receives cash back on adding the bookmarks and review notes and aids previous purchasers of the product to avail the cash back depending on purchaser rules predefined by the laptop provider.

Predefined incentive rules and budget are by set the laptop provider using the enhanced search marketing service to provide monetary benefits to the users clicking the link and the purchasers aiding the user for making the purchase. Monetary benefits can then provided by the enhanced search marketing service to the user and the purchasers based on the predefined incentive rules and budget set by the laptop provider. The monetary benefits can include, but not limited to, cash-back or discounts on the product purchased, gift coupons, and discount coupons.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. An article of manufacture comprising:
a machine-readable medium; and
instructions carried by the machine-readable medium and operable to cause a programmable processor to perform:
generating a link corresponding to a product of an advertiser;
providing the link to a purchaser of the product of the advertiser after purchase of the product;
adding information associated with the product to a list of online bookmarks in response to the purchaser clicking the link, wherein the information comprises a uniform resource locator (URL);
receiving a search query corresponding to the product from a user;
searching the list of online bookmarks; and
displaying the information associated with the product to the user.

2. The article of manufacture of claim 1 further comprising instructions operable to cause the programmable processor to perform:
displaying a web page corresponding to the URL to the user in response to an input from the user;
providing the link to the user after purchase of the product; and
updating the information associated with the product in the list of online bookmarks in response to the user clicking the link.

3. The article of manufacture of claim 2, wherein the updating comprises:
increasing count of number of clicks on the link by one in the list of online bookmarks; and
prioritizing the information associated with the product based on the number of clicks.

4. The article of manufacture of claim 1 further comprising instructions operable to cause the programmable processor to perform:
providing monetary benefits to the purchaser and to the user after purchase of the product based on pre-defined incentive rules.

5. The article of manufacture of claim 1 further comprising instructions operable to cause the programmable processor to perform:
storing the list of online bookmarks.

6. The article of manufacture of claim 1, wherein the providing comprises:
detecting purchase of the product by the purchaser.

7. The article of manufacture of claim 1, wherein the information comprises at least one of:
a review, a rating, a tag, a title, and a note.

8. An article of manufacture comprising:
a machine-readable medium; and
instructions carried by the machine-readable medium and operable to cause a programmable processor to perform:
generating a link corresponding to a product of an advertiser;
receiving a search query corresponding to the product of the advertiser from a user;
searching a list of online bookmarks;
displaying a URL associated with the product to the user;
displaying a web page corresponding to the URL to the user in response to the user clicking the URL;
providing the link to the user after purchase of the product; and
updating information associated with the product in the list of online product bookmarks in response to user inputs.

9. The article of manufacture of claim 8, wherein the updating comprises:
increasing count of number of clicks on the link by one in the list of online bookmarks; and
prioritizing the information associated with the product based on the number of clicks.

10. The article of manufacture of claim 8, wherein the information comprises at least one of:
a review, a rating, a tag, a title, and a note.

11. A computer-implemented method comprising:
generating a link corresponding to a product of an advertiser;
providing the link to a purchaser of the product of the advertiser by the advertiser after purchase of the product;
adding information associated with the product to a list of online bookmarks in response to the purchaser clicking the link, wherein the information comprises a uniform resource locator (URL);
receiving a search query corresponding to the product from a user;
searching the list of online bookmarks; and
displaying the information associated with the product to the user.

12. The computer-implemented method of claim 11 further comprising:
displaying a web page corresponding to the URL to the user in response to an input from the user;
providing the link to the user after purchase of the product; and
updating the information associated with the product in the list of online bookmarks in response to the user clicking the link.

13. The computer-implemented method of claim 12, wherein the updating comprises:
increasing count of number of clicks on the link by one in the list of online bookmarks; and
prioritizing the information associated with the product based on the number of clicks.

14. The computer-implemented method of claim 11 further comprising:
providing monetary benefits to the purchaser and the user after purchase of the product based on pre-defined incentive rules.

15. The computer-implemented method of claim 11 further comprising:
storing the list of online bookmarks.

16. The computer-implemented method of claim 11, wherein the providing comprises:
detecting purchase of the product by the purchaser.

17. The computer-implemented method of claim 11, wherein the information comprises at least one of:
review, tag, title, and note.

18. A system comprising:
a purchaser electronic device for displaying a link associated with a product of an advertiser to a purchaser of the product of the advertiser;
a user electronic device for inputting a search query corresponding to the product;
a communication interface in electronic communication with the purchaser electronic device and the user electronic device;
a storage unit for storing a list of online bookmarks;
a memory for storing instructions; and
a processor responsive to the instructions for adding information associated with the product to the list of online bookmarks in response to the purchaser clicking the link, and displaying the information associated with the product to a user as a search result.

19. The system of claim 18 further comprising:
an advertiser electronic device for registering for the link.
